(19) United States
(12) Patent Application Publication
(10) Pub. No.: US 2021/0227801 A1
(43) Pub. Date: Jul. 29, 2021

(54) Coral Husbandry Automated Raceway Machine

(71) Applicant: Stephen Rodan, Potomac, MD (US)

(72) Inventor: Stephen Rodan, Potomac, MD (US)

(21) Appl. No.: 16/774,177

(22) Filed: Jan. 28, 2020

(51) Int. Cl. A01K 61/20; G06K 9/00; H04N 5/232

(52) U.S. Cl. CPC A01K 61/20; H04N 5/23299; G06K 9/00664

(57) ABSTRACT

An apparatus and method for coral husbandry including a frame configured to attach to an aquaculture raceway, a carriage having a plurality of tools mounted thereon, the carriage being attached to the frame and configured to move relative to the frame, the plurality of tools comprising a rotary tool having a tool member attached thereto, a nozzle configured for at least one-way fluid communication, and an inspection instrument for monitoring and cataloguing coral reef specimens.

### TECHNICAL FIELD

The present invention relates to an apparatus and method for coral husbandry. In particular, the invention relates to a farming machine for cultivating coral reef specimens.

### BACKGROUND

Any references to methods, apparatus or documents of the prior art are not to be taken as constituting any evidence or admission that they formed, or form part of the common general knowledge.

Coral husbandry is the care, cultivation, and breeding of aquatic animals of the superclass Anthozoa. Coral get their energy by means of active feeding or through photosynthetic algae that live in their tissues. Coral reef specimens may be propagated and maintained within captive aquatic environments due to their modular habit, sexual and asexual reproductive mechanisms, and minimal feeding requirements.

Aquaculture for coral offers considerable promise for restoring reefs and preserving biodiversity. Corals can propagate sexually and may be paired with other species to create hybrid genotypes. Corals can also reproduce asexually, which is when a fragment of one coral colony breaks apart into two smaller colonies and are placed onto separate substrates. Asexual propagation is widely referred to as coral fragmentation and is known to accelerate coral growth significantly.

An improved coral aquaculture method consists of a land-based, ex-situ aquarium rearing environment, commonly known as a coral nursery. A coral nursery contains a single (or plurality of) aquarium raceway(s) maintained to grow healthy coral reef specimens with reduced competition and predation. Nurseries typically cultivate coral reef specimens for use in sale, stock, research, and reef restoration.

In the nursery method, larval coral recruits or adult coral colonies have adhered to a substrate base, and henceforth the coral unit is placed among other units on a work surface within a raceway. Nutritious food is added to the aquaculture system. Pests and algae growth are tediously cleaned by tool. Excess waste is removed by water and airflow. Coral health observations are catalogued, and nurseries are periodically drained for maintenance and scrubbing. These nursery tasks are laborious and must be repeated regularly and frequently for each coral unit and raceway assembly.

Presently, the manual labour required in coral husbandry is not economically suitable with respect to long runs and large quantities of coral. Accordingly, it is an object of the present invention to ameliorate one or more of the problems described above.

### SUMMARY OF INVENTION

In an aspect, the invention provides an apparatus for coral husbandry comprising:

a frame configured to attach to an aquaculture raceway;

a carriage having a plurality of tools mounted thereon, the carriage being attached to the frame and configured to move relative to the frame, the plurality of tools comprising:
a rotary tool having a tool member attached thereto;
a nozzle configured for at least one-way fluid communication; and
an inspection instrument for inspecting and cataloguing coral specimens.

Preferably, the apparatus further comprises a carriage frame having the carriage mounted thereto.

Preferably, the nozzle is configured for two-way fluid communication.

Preferably, the apparatus further comprises an aquaculture raceway. Preferably, the carriage frame is attached to the aquaculture raceway.

Preferably, the carriage is configured to move across a width of the aquaculture raceway and along a length of the aquaculture raceway. Preferably, the carriage is configured to move rectilinearly along the aquaculture raceway. Preferably, the carriage is attached to the frame and configured to move rectilinearly relative to the frame

Preferably, the inspection instrument comprises one or more of a sensor and a camera for inspection, electronic cataloguing and monitoring of coral specimens.

Preferably, the rotary tool comprises a brushless motor, a mounted bearing, a spindle and a tool member. Preferably, the brushless motor is connected to the spindle and the mounted bearing. Preferably, the tool member is connected to an end of the spindle. Preferably, the rotary tool comprises a rotary agitator, wherein the tool member comprises a bristle brush.

Preferably, the carriage frame comprises a gantry and a railway. Preferably, the gantry is mounted to the railway and is configured to move along the railway. More preferably, the gantry is configured to move rectilinearly along the railway. Preferably the carriage is attached to the gantry of the carriage frame.

Preferably, the apparatus further comprises a work surface within the aquaculture raceway. Preferably, the work surface is elevated above a base of the aquaculture raceway by spacers. Preferably, the work surface is elevated by the spacers by a fixed distance. Preferably, the apparatus further comprises a plurality of coral units arranged on the work surface. Preferably, a coral unit of the plurality of coral units comprises a single coral polyp or coral colony mounted on a substrate base.

Preferably, the apparatus further comprises a mechanical arm configured to releasably engage and lift a coral unit. Preferably, the mechanical arm is coupled to the carriage.

In another aspect, the invention provides a method for coral husbandry, the method including the steps of:

providing a plurality of coral units in an aquaculture raceway; and

operating an apparatus for coral husbandry as described above to clean and inspect the plurality of coral units.

Preferably, the method further includes the step of moving the carriage to a coral unit or plurality of coral units and operating the tool member of the rotary tool to engage the coral unit to clean the coral unit.

Preferably, the method further includes the step of operating the nozzle to dispense fluid to clean the coral unit.

Preferably, the method further includes the step of operating the inspection instrument to inspect the coral unit. Preferably, the inspection instrument scans the coral unit and determines if the coral unit is clean and/or healthy. Preferably, the inspection instrument photographs the coral unit.

Preferably, the method further includes the step of operating a mechanical arm to engage and lift the coral unit such that the coral unit is operably located adjacent to the tool member.

An apparatus for coral husbandry comprising:

a frame configured to attach to an aquaculture raceway;

a carriage having a plurality of tools mounted thereon, the carriage being attached to the frame and configured to move relative to the frame, the plurality of tools comprising one or more of:
a rotary tool having a tool member attached thereto;
a nozzle configured for at least one-way fluid communication; and
an inspection instrument for inspecting and cataloguing coral specimens.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates an apparatus for coral husbandry according to an embodiment of the present invention;

FIG. 2 illustrates the apparatus of FIG. 2 showing the water removed from the aquaculture raceway;

FIG. 3 illustrates a work surface having a number of coral units thereon for use with the apparatus of FIG. 1;

FIG. 4 illustrates the tools of the apparatus according to an embodiment of the present invention;

FIG. 5 illustrates the carrier attending to coral units;

FIGS. 6a-c illustrate the carrier from a number of perspectives;

FIG. 7 illustrates axes the carrier and carriage frame move along;

FIG. 8 illustrates the aquaculture raceway of the present invention.

### DETAILED DESCRIPTION OF PREFERRED EMBODIMENTS

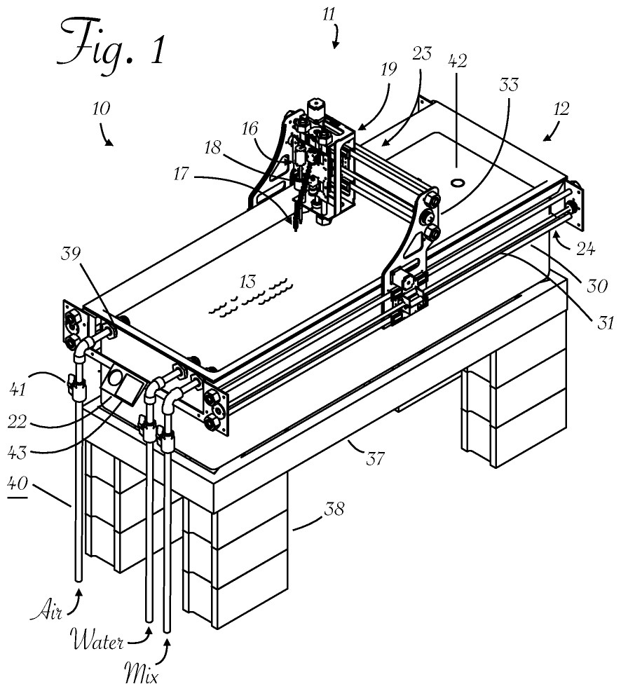

Referring to the drawings, as seen in FIG. 1, there is illustrated an embodiment of the present invention in the form of a coral husbandry apparatus 10 including a cleaning apparatus 11 and an aquaculture raceway 12.

The coral husbandry apparatus 10 provides for the culturing of coral reef specimens in the raceway 12 using a computer-controlled cleaning apparatus 11 including a carriage in the form of carrier 19 having a number of interoperable tools for attending to the coral reef specimens.

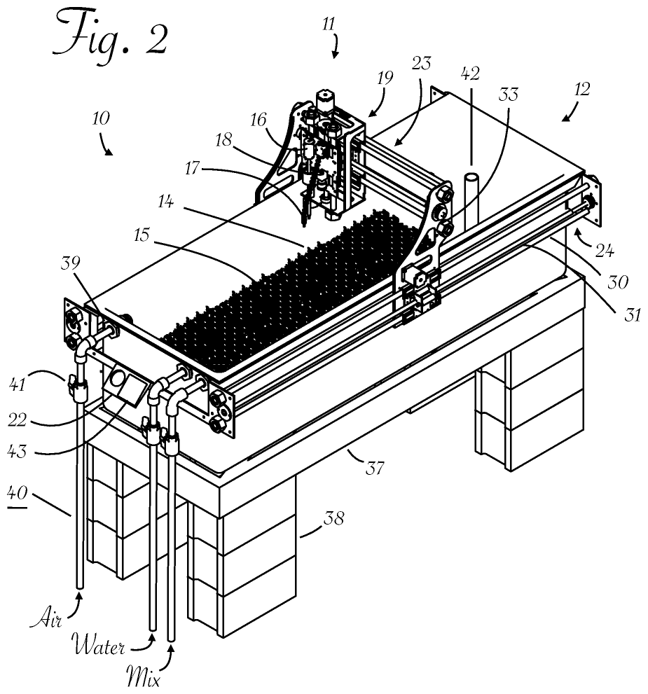

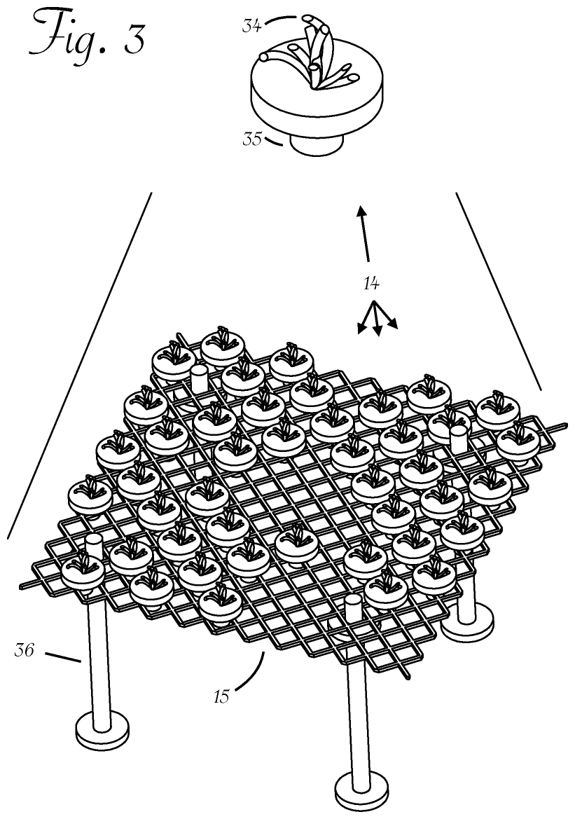

FIG. 2 depicts a state of the coral husbandry apparatus 10 when the raceway 12 is drained of racing water 13 to expose an array of coral units 14 mounted on a work surface 15 (See FIG. 3).

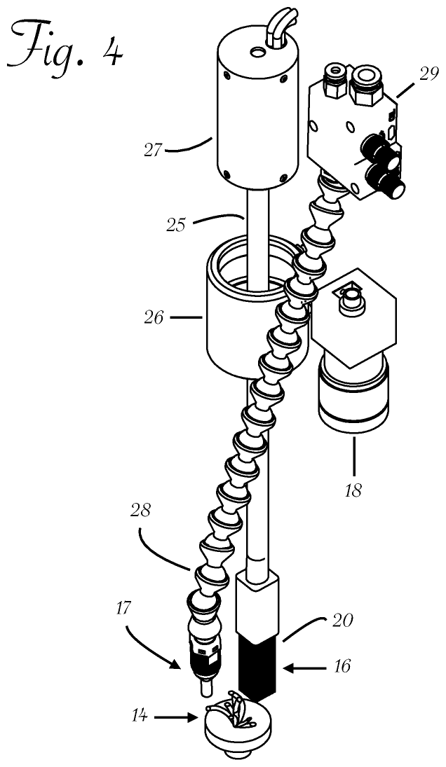

FIG. 4 illustrates the coral unit 14 positioned below, around, and adjacent to the tools including a rotary tool in the form of a rotary agitator 16, a nozzle 17, and inspection instrument 18.

The tools are mounted on the carrier 19 within the raceway 12 and are positioned a desirable distance above the work surface 15 with means to traverse a bristle brush 20 attached to the rotary agitator 16 rectilinearly across the coral units 14 in order to cultivate and clean the coral specimens.

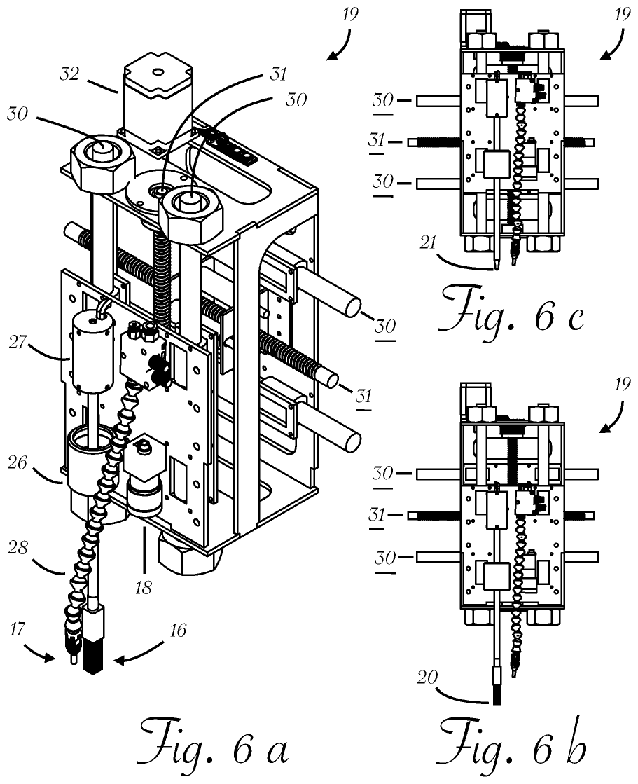

Turning to FIG. 6a, the carrier 19 is shown in more detail. In FIGS. 6b and 6c, the carrier 19 is shown with a variety of tools attached thereto suitable for specific husbandry tasks. In one embodiment shown in FIG. 6b, the carrier 19 includes a bristle brush 20. In an alternative embodiment, the carrier 19 includes a diamond tip 21 in FIG. 6c. The diamond tip 21 is particularly useful for removing fragments of living, dead, or diseased portions of the coral colony. In some embodiments, a rotary tip made of a diamond composite may be used for fragmenting corals or cutting through substrate.

As mentioned above, the tools and instruments embodied in the cleaning apparatus 11 as seen in FIGS. 1, 2, and 4-7 include a rotary agitator 16, a nozzle 17 and an inspection instrument 18. Such tools are mounted to the carrier 19 operable by a computer terminal 22 in order to move multiaxially and traverse rectilinearly on a carriage frame in the form of a gantry 23 and railway 24.

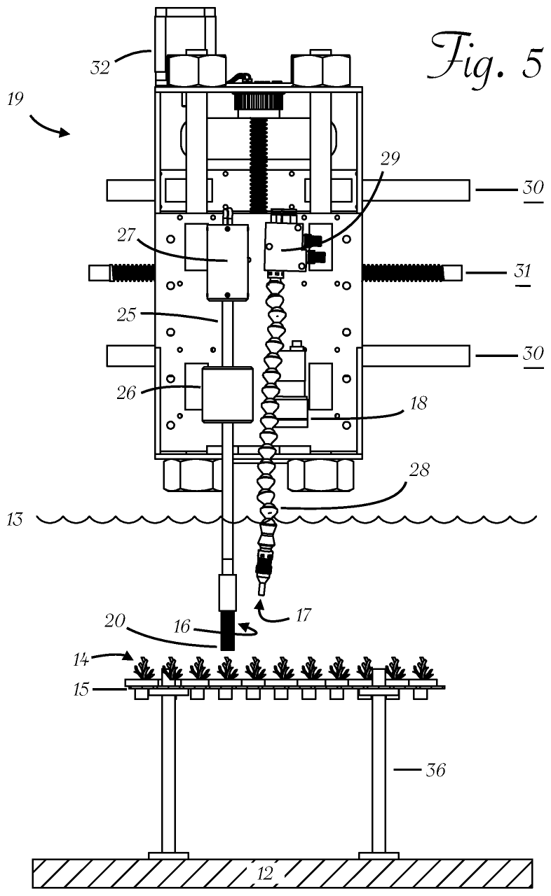

For illustrative purposes, some components are omitted in some figures. For example, in FIG. 4, the carrier 19 on which the tools are mounted is omitted with only the tools being shown. In a further example, in FIGS. 5 and 6a-c, the carrier 19 is shown in isolation from the gantry 23 and railway 24.

The rotary agitator 16 includes an operable tool member in the form of a bristle brush 20, a spindle 25, a mounted bearing 26, and a brushless motor 27. The brushless motor 27 is connected to the carrier 19, which is in turn connected to the spindle 25 and the mounted bearing 26. Located at an end of the spindle 25 is the bristle brush 20. In use, the brushless motor 27 rotates the spindle 25 which the bristle brush 20 is attached to. This allows the bristle brush 20 to clean the coral specimens 14.

The nozzle 17 is convertible between air or liquid and blast or suction with flow control means thereby providing two-way fluid communication (i.e. in and out of the nozzle 17). In some embodiments, the nozzle 17 is configured for only one-way fluid communication (i.e. either in or out). The nozzle 17 is attached to flexible tubing 28 and a manifold 29 with influent and effluent feed.

The inspection instrument 18 is oriented at a target area below and around the rotary agitator 16 and nozzle 17 to view the principal objective. The rotary agitator 16, nozzle 17 and inspection instrument 18 may be operated manually or automatically by the computers virtual terminal 22. The rotary agitator 16, nozzle 17 and inspection instrument 18 depicted in FIGS. 1, 2 and 5-7 move along a set of slide rails 30 provided within the carrier 19, gantry 24 and railway 24.

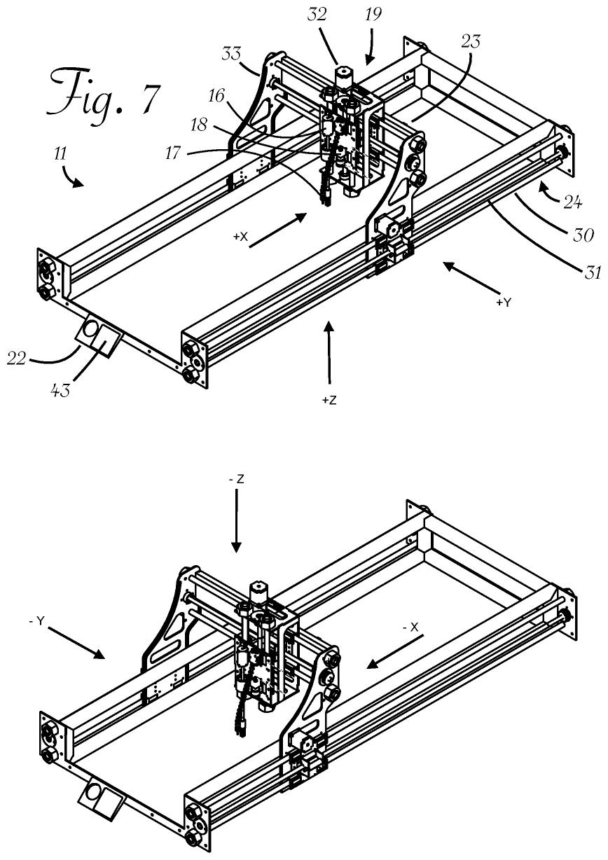

Illustrated in FIGS. 6 and 7, the rotary agitator 16, nozzle 17 and inspection instrument 18 are multiaxially displaceable along an x-, y- and z-axis by means of the slide rails 30 and threaded members 31 arranged orthogonally relative to the carrier 19 and driven by servo motors 32 suitably programmed and operated by the computer's virtual terminal 22 in a conventional manner.

More particularly, the gantry 23 moves longitudinally along slide rails 30 of the railway 24 to move the carrier 19 along the length of the raceway 12 (i.e. along the x-axis).

The carrier 19 is also configured to move laterally along the slide rails 30 of the gantry 23 to move the carrier 19 along the width of the raceway 12 (i.e. along the y-axis).

The carrier 19 also includes vertically arranged slide rails 30 which allow an instrument panel which the tools and instruments (i.e. rotary agitator 16, nozzle 17 and inspection instrument 18) are mounted to, to move vertically relative to the raceway 12 (i.e. along the z-axis).

Seen in FIG. 7, a set of vertical legs 33 support the gantry 23 above the work surface 15 as the rotary agitator 16, nozzle 17 and inspection instrument 18 to attend to the coral.

As illustrated in FIGS. 2, 3 and 5, a coral unit 14 includes a single coral polyp or colony 34 mounted on a substrate base 35. A group of coral units 14 are arranged as desired within the boundaries of a work surface 15 elevated by spacers 36 a fixed distance above the bottom of the raceway 12.

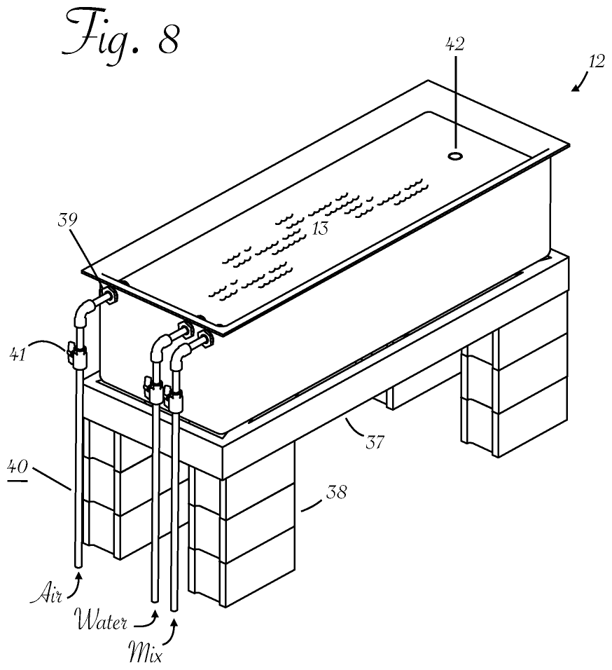

In FIG. 8, a coral nursery raceway 12 rests on a frame 37 supported by blocks 38. A raceway 12 includes a bottom panel and a set of side panels (which may be transparent) to provide an upper opening. The raceway 12 is attached by bulkhead adapter 39, pipe 40, and ball valve 41 to fill the raceway 12 with influent water, gas or mixed feed. Effluent water containing undesired waste flows out of the system through a drain 42.

In the use of the apparatus 10 as described to clean and cultivate a coral, the coral unit 14 is positioned on the work surface 15 in the raceway 12. Thus positioned, the machine controls are operated pursuant to the inputted program in a conventional manner. In particular, a user selects a program sequence using a computer to clean coral. When prompted, the carrier 19 switches to the appropriate tool (such as the bristle brush 20, for example) and begins to clean away algae automatically and until completion. The software and inspection instrument 18 (which includes a camera) can detect corals and clean around them safely and until completion. This is described in further detail below.

Living coral tissue is cleaned by bristle brush 20, excess waste is removed by nozzle 17, and health observations are catalogued by the inspection instrument 18. The progress of the compliant action may be monitored by a viewport 43 provided on the computer's virtual terminal 22. With the husbandry tasks having been completed, the coral units 14 may be repositioned within the raceway 12 manually or automatically. In such a case, when prompted, the carrier 19 couples with a coral unit substrate base 35 (using a mechanical arm, for example) and lifts the coupled pair vertically above the work surface 15 plane. Manoeuvring to an accessible location within the raceway 12 boundaries, the carrier 19 lowers the coral unit 14 to the work surface 15 and releases it to complete the task. The carrier 19 may retract to a vertical position above the raceway 12 as shown in FIG. 1 or continue to the next queued task. The coral units 14 remain stored for further culturing or are assembled for sale, stock, manufacture, and/or reef restoration.

In some embodiments, the carrier 19 couples with a coral unit substrate base 35, lifts the coupled pair vertically above the work surface 15 plane and manoeuvres to an accessible location outside the raceway 12 boundaries. The carrier 19 then lowers the coral unit 14 to a surface, such as the work surface of another raceway or into a carrying case for transport, for example.

It is an object of embodiments of the invention to economically automate the cultivation of coral while utilising a minimal amount of manual time and labour.

Furthermore, benefits of embodiments of the present invention include yielding healthier and higher volumes of coral, a reduction in handling-stress to coral, minimised exposure to pathogenic factors, faster growth rates, and improved cataloguing techniques.

Embodiments of the present invention provide a simple, efficient and economic way to cultivate large and small quantities of coral aquaculture without incurring the expense of manual labour typically used in conventional coral husbandry.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. An apparatus for coral husbandry comprising:
a frame configured to attach to an aquaculture raceway;
a carriage having a plurality of tools mounted thereon, the carriage being attached to the frame and configured to move relative to the frame, the plurality of tools comprising:
a rotary tool having a tool member attached thereto;
a nozzle configured for at least one-way fluid communication; and
an inspection instrument for inspecting and cataloguing coral specimens.

2. An apparatus for coral husbandry according to claim 1, wherein the apparatus further comprises an aquaculture raceway and the carriage frame is attached to the aquaculture raceway.

3. An apparatus for coral husbandry according to claim 1 or claim 2, wherein the carriage is configured to move across a width of the frame, along a length of the frame and wherein a portion of the carriage is configured to move vertically relative to the frame.

4. An apparatus for coral husbandry according to any one of claims 1 to 3, wherein the inspection instrument comprises one or more of a sensor and a camera for inspection, electronic cataloguing and monitoring of coral specimens.

5. An apparatus for coral husbandry according to any one of claims 1 to 4, wherein the rotary tool comprises a brushless motor, a mounted bearing and a spindle, wherein the brushless motor is connected to the spindle and the mounted bearing and the tool member is connected to an end of the spindle.

6. An apparatus for coral husbandry according to any one of claims 1 to 5, wherein the tool member comprises a bristle brush.

7. An apparatus for coral husbandry according to any one of claims 1 to 6, wherein the frame comprises a gantry and a railway and wherein the gantry is mounted to the railway and is configured to move along rectilinearly the railway.

8. An apparatus for coral husbandry according to any one of claims 1 to 7, wherein the apparatus further comprises a work surface within the aquaculture raceway and a plurality of coral units, wherein the work surface is elevated above a base of the aquaculture raceway by spacers and wherein a coral unit of the plurality of coral units comprises a single coral polyp or coral colony mounted on a substrate base.

9. An apparatus for coral husbandry according to any one of claims 1 to 8, wherein the apparatus further comprises a mechanical arm configured to releasably engage and lift a coral unit and wherein the mechanical arm is coupled to the carriage.

10. An apparatus for coral husbandry according to any one of claims 1 to 9, wherein the nozzle is configured for two-way fluid communication.

11. A method for coral husbandry, the method including the steps of:
providing a plurality of coral units in an aquaculture raceway; and
operating an apparatus for coral husbandry comprising a frame attached to the aquaculture raceway, a carriage having a plurality of tools mounted thereon, the carriage being attached to the frame and configured to move relative to the frame, the plurality of tools comprising a rotary tool having a tool member attached thereto, a nozzle configured for at least one-way fluid communication, and an inspection instrument, to clean, cultivate, and inspect the plurality of coral units.

12. A method for coral husbandry according to claim 11, wherein the method further includes the step of moving the carriage to a coral unit of the plurality of coral units and operating the tool member of the rotary tool to engage the coral unit.

13. A method for coral husbandry according to claim 11 or claim 12, wherein the method further includes the step of operating the nozzle to dispense fluid to clean and/or feed the coral unit.

14. A method for coral husbandry according to any one of claims 11 to 13, wherein the method further includes the step of operating the inspection instrument to inspect the coral unit.

15. A method for coral husbandry according to claim 14, wherein the inspection instrument inspects the coral unit and determines if the coral unit is healthy.

16. A method for coral husbandry according to claim 14 or claim 15, wherein the inspection instrument photographs the coral unit.

17. A method for coral husbandry according to any one of claims 11 to 16, wherein the method further includes the step of operating a mechanical arm to engage and lift the coral unit such that the coral unit is operably located adjacent to the tool member.

18. An apparatus for coral husbandry comprising:
a frame configured to attach to an aquaculture raceway;
a carriage having a plurality of tools mounted thereon, the carriage being attached to the frame and configured to move relative to the frame, the plurality of tools comprising one or more of:
a rotary tool having a tool member attached thereto;
a nozzle configured for at least one-way fluid communication; and
an inspection instrument for inspecting and cataloguing coral specimens.
